(19) United States
(12) Patent Application Publication
(10) Pub. No.: US 2026/0048934 A1
(43) Pub. Date: Feb. 19, 2026

(54) RATCHETING LOCK FOR GRABBER ASSEMBLY

(71) Applicant: The Heil Co., Chattanooga, TN (US)

(72) Inventor: Ethan Lee Maness, Rainsville, AL (US)

(21) Appl. No.: 19/297,801

(22) Filed: Aug. 12, 2025

Related U.S. Application Data
(60) Provisional application No. 63/682,659, filed on Aug. 13, 2024.
(60) Provisional application No. 63/682,639, filed on Aug. 13, 2024.

(51) Int. Cl. B65F 3/02; B65F 3/04

(52) U.S. Cl. CPC B65F 3/02; B65F 3/041; B65F 2003/023; B65F 2003/0279

(57) ABSTRACT

A refuse collection vehicle including a wheeled vehicle chassis and a refuse collection body coupled to the wheeled vehicle chassis. The refuse collection body has a grabber assembly to engage a refuse container and position the refuse container relative to the refuse collection body. The grabber assembly includes a first grabber arm, a second grabber arm, and a ratcheting pawl. The first grabber arm and the second grabber arm move between an open position and a closed position. The ratcheting pawl is operable between an engaged position and a disengaged position. The ratcheting pawl is configured to prevent rotation of the first grabber arm and the second grabber arm when the ratcheting pawl is in the engaged position.

### CROSS-REFERENCE TO RELATED APPLICATION

This application claims the benefit under 35 U.S.C. § 119(e) of U.S. Patent Application No. 63/682,659, entitled “RATCHETING LOCK FOR GRABBER ASSEMBLY,” filed Aug. 13, 2024, and U.S. Patent Application No. 63/682,639, entitled “LINEAR DRIVE FOR GRABBER ASSEMBLY,” filed Aug. 13, 2024, which are incorporated herein by reference in their entirety.

### TECHNICAL FIELD

This disclosure relates to systems and methods for operating a refuse collection vehicle.

### BACKGROUND

Refuse collection vehicles have been used for generations for the collection and transfer of waste to landfills, recycling centers, or treatment facilities. Refuse collection vehicles can include a refuse storage body, an intermediate container, and a grabber assembly to move a customer refuse container containing refuse into a position for moving refuse from the customer refuse container into the intermediate container.

### SUMMARY

Various aspects of the disclosure relate to operating a refuse collection vehicle. In an example aspect, the refuse collection vehicle includes a wheeled vehicle chassis and a refuse collection body coupled to the wheeled vehicle chassis. The refuse collection body has a grabber assembly configured to engage a refuse container and position the refuse container relative to the refuse collection body. The grabber assembly has a first grabber arm, a second grabber arm, and a ratcheting pawl. The first grabber arm and the second grabber arm move between an open position and a closed position. The ratcheting pawl is operable between an engaged position and a disengaged position. The ratcheting pawl prevent rotations of the first grabber arm and the second grabber arm when the ratcheting pawl is in the engaged position.

In an example aspect combinable with any other example aspect, the ratcheting pawl, when in the disengaged position, does not prevent rotation of the first grabber arm and the second grabber arm.

In an example aspect combinable with any other example aspect, the ratcheting pawl rotates counterclockwise to move from the disengaged position to the engaged position and clockwise to move from the engaged position to the disengaged position.

In an example aspect combinable with any other example aspect, the ratcheting pawl rotates about a center axis between the disengaged position and the engaged position.

In an example aspect combinable with any other example aspect, the grabber assembly includes a ratcheting pawl motor operatively coupled to the ratcheting pawl. The ratcheting pawl motor rotates the ratcheting pawl between the disengaged position and the engaged position.

In an example aspect combinable with any other example aspect, the grabber assembly includes an axle coupling the ratcheting pawl to the ratcheting pawl motor.

In an example aspect combinable with any other example aspect, the ratcheting pawl defines a void shaped to couple the ratcheting pawl to the axle.

In an example aspect combinable with any other example aspect, the void extends from a top surface of the ratcheting pawl to a bottom surface of the ratcheting pawl.

In an example aspect combinable with any other example aspect, the grabber assembly includes a fastener to couple the axle to the ratcheting pawl.

In an example aspect combinable with any other example aspect, the fastener includes a washer and a bolt.

In an example aspect combinable with any other example aspect, the grabber assembly includes a ratcheting pawl motor plate. The ratcheting pawl motor plate couples the axle to the ratcheting pawl motor.

In an example aspect combinable with any other example aspect, the grabber assembly includes a first bearing assembly and a second bearing assembly. The first bearing assembly is coupled to the first grabber arm. The second bearing assembly is coupled to the second grabber arm.

In an example aspect combinable with any other example aspect, the grabber assembly includes a first ratchet gear and a second ratchet gear. The first ratchet gear is coupled to a first pivot pin of the first bearing assembly. The second ratchet gear is coupled to a second pivot pin of the second bearing assembly.

In an example aspect combinable with any other example aspect, the ratcheting pawl has first surface and a second surface. The first surface engages the first ratchet gear. The second surface engages the second ratchet gear.

In an example aspect combinable with any other example aspect, the first surface and the second surface are curved.

In an example aspect combinable with any other example aspect, the first surface and the second surface are parallel flat surfaces.

In an example aspect combinable with any other example aspect, the first surface and the second surface are angled relative to a longitudinal axis of the ratcheting pawl.

In an example aspect combinable with any other example aspect, the first surface has a first set of teeth shaped to engage the first ratchet gear and the second surface has a second set of teeth shaped to engage the second ratchet gear.

In an example aspect combinable with any other example aspect, the first set of teeth is angled relative to the first surface and the second set of teeth is angled relative to the second surface.

In an example aspect combinable with any other example aspect, the first set of teeth is oriented in an opposite direction from the second set of teeth.

In an example aspect combinable with any other example aspect, the ratcheting pawl includes a first arm and a second arm. The first arm to engages and disengages the first ratchet gear. The second arm engage and disengages the second ratchet gear.

In an example aspect combinable with any other example aspect, side surfaces of the first arm and the second arm are curved.

In an example aspect combinable with any other example aspect, the grabber assembly has a grabber motor operatively coupled to the first grabber arm and the second grabber arm. The grabber motor moves the first grabber arm and the second grabber arm between the open position and the closed position.

In an example aspect combinable with any other example aspect, the grabber assembly incudes a ball screw gear assembly coupled to the grabber motor. The ball screw gear assembly has a ball screw gear shaft, a ball screw bearing, and a housing. The ball screw gear shaft defines a first end and a second end. The first end is coupled to the grabber motor. The ball screw bearing is coupled to the second end of the ball screw shaft. The housing is coupled to the ball screw shaft. The housing is coupled to the first grabber arm and the second grabber arm. The housing moves along the ball screw shaft responsive to rotation of the ball screw shaft by the grabber motor and responsive to the housing moving along the ball screw shaft, rotate the first grabber arm and the second grabber arm.

In an example aspect combinable with any other example aspect, the grabber assembly incudes a pad coupled to the ball screw bearing and positioned to contact the refuse container.

In an example aspect combinable with any other example aspect, the grabber assembly has a control system. The control system includes a sensor and a controller. The sensor senses a configuration of the grabber assembly and transmits a signal representing the configuration of the grabber assembly. The controller is operatively coupled to the grabber assembly. The controller performs operations including receiving the signal representing the configuration of the grabber assembly from the sensor and based on the signal, controls movement of the grabber assembly.

In an example aspect combinable with any other example aspect, sensing the configuration of the grabber assembly includes sensing a condition of the ratcheting pawl.

In an example aspect combinable with any other example aspect, sensing the condition of the ratcheting pawl includes sensing that the ratcheting pawl is positioned in the disengaged position or the engaged position.

In an example aspect combinable with any other example aspect, sensing the condition of the ratcheting pawl includes detecting a rotational angle of an axle coupling the ratcheting pawl to the ratcheting pawl motor.

In an example aspect combinable with any other example aspect, the ratcheting pawl motor includes a bi-directional motor rotate the ratcheting pawl motor in a clockwise direction or a counterclockwise direction. The controller transmits a clockwise command signal or a counterclockwise command signal to the bi-directional motor based on the condition of the ratcheting pawl.

In an example aspect combinable with any other example aspect, sensing the configuration of the grabber assembly includes sensing the position of the first grabber arm and the second grabber arm.

In an example aspect combinable with any other example aspect, sensing the position of the first grabber arm and the second grabber arm includes sensing that the first grabber arm and the second grabber arm are in the open position or the closed position.

In an example aspect combinable with any other example aspect, controlling movement of the grabber assembly includes positioning the first grabber arm and the second grabber arm in the open position or the closed position.

In an example aspect combinable with any other example aspect, controlling movement of the grabber assembly includes positioning the ratcheting pawl in the engaged position or the disengaged position.

In an example aspect combinable with any other example aspect, controlling movement of the grabber assembly includes causing the ratcheting pawl to rotate from the disengaged position to the engaged position and stopping a flow of power to the grabber motor.

In an example aspect combinable with any other example aspect, controlling movement of the grabber assembly includes causing the ratcheting pawl to rotate from the engaged position to the disengaged position and causing power to be provided to the grabber motor.

In another example aspect, a refuse collection vehicle has a chassis, a refuse collecting body, a front loading arm assembly, an intermediate container, and a grabber assembly. The refuse collecting body is supported by the chassis. The front loading arm assembly is coupled to the refuse collecting body. The intermediate container receives refuse. The intermediate container is coupled to the front loading arm assembly. The grabber assembly engages a refuse container. The grabber assembly includes a first grabber arm, a second grabber arm, and a ratcheting pawl. The first grabber arm and the second grabber arm move between an open position and a closed position. The ratcheting pawl is operable between an engaged position and a disengaged position. The ratcheting pawl prevents rotation of the first grabber arm and the second grabber arm when the ratcheting pawl is in the engaged position.

In yet an example aspect, a grabber assembly couples to a refuse collection vehicle. The grabber assembly has a first ratchet gear, a second ratchet gear, a ratcheting pawl, and a ratcheting pawl motor. The first ratchet gear couples to a first bearing assembly. The first bearing assembly rotates a first grabber arm coupled to the first bearing assembly. The second ratchet gear couples to a second bearing assembly. The second bear assembly rotates a second grabber arm coupled to the second bearing assembly. The ratcheting pawl is operable between an engaged position and a disengaged position. The ratcheting pawl prevents rotation of the first ratchet gear and the second ratchet gear when the ratcheting pawl is in the engaged position. The ratcheting pawl motor is operatively coupled to the ratcheting pawl. The ratcheting pawl motor rotates the ratcheting pawl between the disengaged position and the engaged position.

In another example aspect, a method for operating a grabber assembly of a refuse collection vehicle includes rotating a ratcheting pawl of the grabber assembly of the refuse collection vehicle from a disengaged position to an engaged position. Rotation of a first grabber arm and a second grabber arm is prevented when the ratcheting pawl is in the engaged position.

In an example aspect combinable with any other example aspect, operating the grabber assembly of the refuse collection vehicle includes rotating the ratcheting pawl from the engaged position to the disengaged position. Rotation of the first grabber arm and the second grabber arm is not prevented when the ratcheting pawl is in the engaged position.

In an example aspect combinable with any other example aspect, operating the grabber assembly of the refuse collection vehicle includes receiving a signal representing a configuration of the grabber assembly and operating the grabber assembly based on the configuration of the grabber assembly.

In an example aspect combinable with any other example aspect, operating the grabber assembly of the refuse collection vehicle includes sensing the configuration of the grabber assembly.

In an example aspect combinable with any other example aspect, sensing the configuration of the grabber assembly includes sensing a condition of the ratcheting pawl.

In an example aspect combinable with any other example aspect, sensing the condition of the ratcheting pawl includes sensing whether the ratcheting pawl positioned in the disengaged position or the engaged position.

In an example aspect combinable with any other example aspect, sensing the condition of the ratcheting pawl includes sensing a rotational angle of an axle coupling the ratcheting pawl to a ratcheting pawl motor operatively coupled to the ratcheting pawl.

In an example aspect combinable with any other example aspect, operating the grabber assembly of the refuse collection vehicle includes rotating the ratcheting pawl from the engaged position to the disengaged position.

In an example aspect combinable with any other example aspect, operating the grabber assembly of the refuse collection vehicle includes generating a clockwise command signal to rotate a ratcheting pawl motor coupled to the ratcheting pawl in a clockwise direction and rotating the ratcheting pawl from the engaged position to the disengaged position based on receiving the clockwise command signal at the ratcheting pawl motor.

In an example aspect combinable with any other example aspect, rotating the ratcheting pawl from the disengaged position to the engaged position includes generating a counterclockwise command signal to rotate a ratcheting pawl motor coupled to the ratcheting pawl in a counterclockwise direction and rotating the ratcheting pawl from the disengaged position to the engaged position based on receiving the counterclockwise command signal at the ratcheting pawl motor.

In an example aspect combinable with any other example aspect, sensing the configuration of the grabber assembly includes sensing a position of the first grabber arm and the second grabber arm.

In an example aspect combinable with any other example aspect, sensing the position of the first grabber arm and the second grabber arm includes sensing whether the first grabber arm and the second grabber arm are in an open position or a closed position.

In an example aspect combinable with any other example aspect, operating the grabber assembly of the refuse collection vehicle includes positioning the first grabber arm and the second grabber arm in the open position or the closed position.

In an example aspect combinable with any other example aspect, operating the grabber assembly of the refuse collection vehicle includes causing the ratcheting pawl to rotate from the disengaged position to the engaged position and stopping a flow of power to a grabber motor operatively coupled to the first grabber arm and the second grabber arm.

In an example aspect combinable with any other example aspect, operating the grabber assembly causing the ratcheting pawl to rotate from the engaged position to the disengaged position and causing power to be provided to the grabber motor.

In another example aspect, a grabber system for loading refuse includes a frame, a first arm, a second arm, and linear drive mechanism. The first arm assembly is pivotally coupled to the frame. The second arm assembly is pivotally coupled to the frame. The linear drive mechanism is coupled to the frame and operable to move the first arm assembly and the second arm assembly between an open position and a closed position to grab a refuse container.

In an example aspect combinable with any other example aspect, each of the first arm assembly and the second arm assembly include an arm having a front portion in front of a pivot point on the frame and a rear portion to the rear of the pivot point on the frame. The linear drive mechanism draws the rear portions of the arms back from the refuse container such that the front portion of the arms close on the refuse container. The linear drive mechanism advances the rear portions of the arms toward the refuse container such that the front arms open away from the refuse container.

In an example aspect combinable with any other example aspect, the linear drive mechanism includes one or more electric motors.

In an example aspect combinable with any other example aspect, the linear drive mechanism includes one or more ball screw mechanisms coupled to an arm of each of the first arm assembly and the second arm assembly.

In an example aspect combinable with any other example aspect, the grabber system includes a mechanism operable to hold open the arms of the grabber system.

In an example aspect combinable with any other example aspect, the mechanism includes a ratchet coupled to at least one of the first arm assembly or the second arm assembly.

In an example aspect combinable with any other example aspect, the grabber system includes one or more sensors to sense a characteristic of at least one component of the grabber system.

In an example aspect combinable with any other example aspect, the grabber system includes a processor coupled to the linear drive mechanism and operates the linear drive mechanism to move the first arm assembly and the second arm assembly between the open position and the closed position.

In yet another example aspect, a refuse collection system includes a refuse-receiving container and a refuse loading mechanism. The refuse loading mechanism is coupled to the refuse-receiving container and transfers refuse into the refuse-receiving container. The refuse loading mechanism includes a grabber system. The grabber system has a frame, a first arm assembly, a second arm assembly, and a linear drive mechanism. The first arm assembly is pivotally coupled to the frame. The second arm assembly is pivotally coupled to the frame. The linear drive mechanism is coupled to the frame and operable to move the first arm assembly and the second arm assembly between an open position and a closed position to grab a refuse container.

In another example aspect, a system for loading refuse has a grabber system and a container lift mechanism. The grabber system includes a frame, a first arm, a second arm, and a linear drive mechanism. The first arm assembly is pivotally coupled to the frame. The second arm assembly is pivotally coupled to the frame. The linear drive mechanism is coupled to the frame and operable to move the first arm assembly and the second arm assembly between an open position and a closed position to grab a refuse container. The container lift mechanism couples between the grabber system and a refuse collection vehicle and is operable to lift a refuse container held by the grabber system to empty contents of the refuse container into the refuse collection vehicle.

In an example aspect combinable with any other example aspect, the grabber system includes a horizontal positioning system to move the container lift mechanism in and out relative the body of the refuse collection vehicle.

In yet another aspect, a method of handling refuse includes positioning a grabber next to a refuse container and drawing back a rear portion of each of a pair of arms pivotally coupled to a frame to close the arms on a refuse container.

In an example aspect combinable with any other example aspect, handling refuse includes lifting the refuse container while the arms hold the refuse container.

In an example aspect combinable with any other example aspect, handling refuse includes tipping the container to empty contents of the container into a refuse collection vehicle.

In an example aspect combinable with any other example aspect, handling refuse includes advancing the rear portion of each of the pair of arms to open the arms to such that the refuse container is released from the arms.

In an example aspect combinable with any other example aspect, the rear portion of the arms are commonly coupled to one another.

In an example aspect combinable with any other example aspect, handling refuse includes drawing back the rear portion of the arms includes operating a linear drive mechanism.

In an example aspect combinable with any other example aspect, drawing back the rear portion of the arms includes turning a screw of a ball screw mechanism.

In an example aspect combinable with any other example aspect, handling refuse includes operating a braking device to inhibit motion of the arms.

One or more implementations described in the present specification may reduce energy consumption by the refuse collection vehicle. For example, by mechanically holding the grabber arms in an open position with a ratcheting pawl, electrical energy used to hold the grabber arms open with a motor can be eliminated, reducing electrical energy consumption by the vehicle.

Implementations of this disclosure may also increase the lifespan for components of the refuse collection vehicle. For example, by mechanically locking the grabber arms in the open position with a ratcheting pawl, run time for a grabber arm motor holding the grabber arms in the open position is reduced, increasing the lifespan of the grabber arm motor.

Implementations of the present disclosure may reduce the need for expensive, heavy, and/or complex components with high maintenance costs. For example, by operating the grabber arms with the ball screw assembly, two motors operating pivot pins on conventional grabber assemblies can be eliminated.

Implementations of the present disclosure may make a refuse collection system easier to maintain. For example, the ball screw assembly can be easily accessed and lubricated.

Implementations of the present disclosure may increase reliability, sustainability, and effectiveness of a refuse collection system. For example, the ball screw assembly can have improved reliability compared to the conventional grabber assembly.

Implementations of the present disclosure may make collection of refuse more energy-efficient. For example, the quantity of electrical energy used to operate the ball screw assembly can be less than the energy required to operate the conventional grabber assembly.

It is appreciated that methods in accordance with the present specification may include any combination of the aspects and features described herein. That is, methods in accordance with the present specification are not limited to the combinations of aspects and features specifically described herein, but also include any combination of the aspects and features provided.

The details of one or more implementations of the subject matter described in this disclosure are set forth in the accompanying drawings and the description below. Other features, objects, and advantages of the subject matter will be apparent from the description and drawings, and from the claims.

### BRIEF DESCRIPTION OF DRAWINGS

FIG. 1 is a side perspective view of a refuse collection vehicle with an intermediate container and a grabber assembly in an open position to accept a customer refuse container containing refuse.

FIG. 2 is a perspective view of the grabber assembly of FIG. 1 in the open position.

FIG. 3 is a perspective view of the grabber assembly of FIG. 1 in a closed position.

FIG. 4 is a top perspective view of the grabber assembly of FIG. 1 in the open position.

FIG. 5 is a top perspective view of the grabber assembly of FIG. 1 in the closed position.

FIG. 6 is a rear bottom perspective view of the grabber assembly of FIG. 1 in the open position.

FIG. 7 is a rear top perspective view of the grabber assembly of FIG. 1 in the open position.

FIG. 8 is a side perspective view of the grabber assembly of FIG. 1.

FIG. 9 is a top perspective view of the grabber assembly of FIG. 1 with the ratcheting pawl engaged to the grabber arm gears.

FIG. 10 is a top perspective view of the grabber assembly of FIG. 1 with the ratcheting pawl disengaged from the grabber arm gears.

FIG. 11 is a flow chart of an example method of operating a grabber assembly of a refuse collection vehicle according to the implementations of the present disclosure.

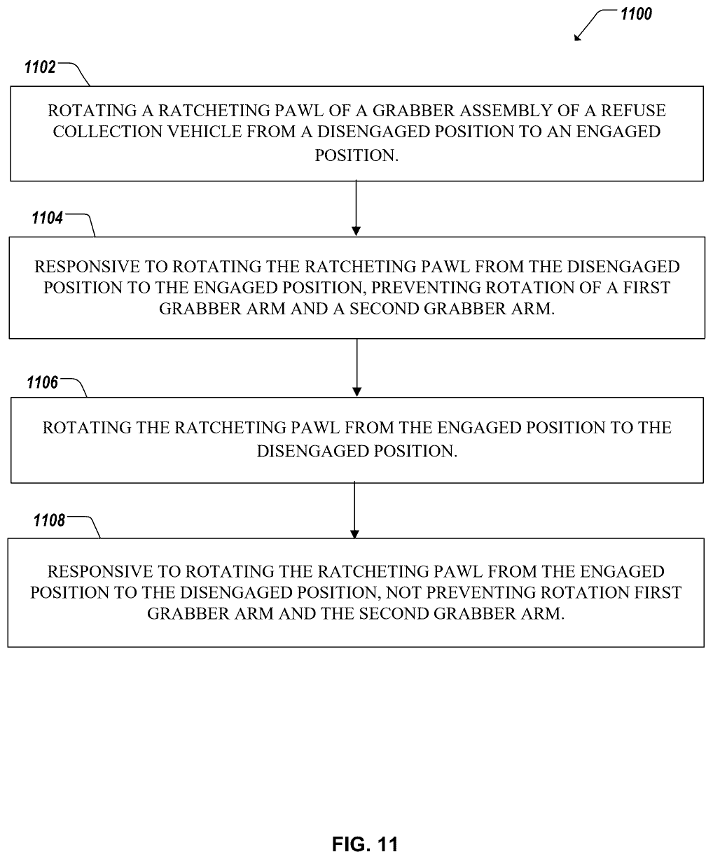

### DETAILED DESCRIPTION

A refuse collection vehicle collects refuse from customer refuse containers by depositing refuse from a customer refuse container into a refuse collection body or into an intermediate container using a grabber assembly to engage, reposition, and disengage the customer refuse container. The grabber assembly has two grabber arms that move between an open position and a closed position to engage and disengage the customer refuse container, respectively. In some implementations, movement of the grabber assembly is controlled using an electric motor, and maintaining the grabber arms in either the open or closed position requires electric motors powering the grabber arms to produce a holding torque, which can continually drain an electrical power source powering the electric motors. A ratcheting pawl can be operated to engage and disengage the grabber arms to maintain a position of the grabber arms. When the ratcheting pawl is engaged to the grabber arms, the rotation of grabber arms is prevented, thus enabling the electrical motors to be deenergized to stop producing the holding torque.

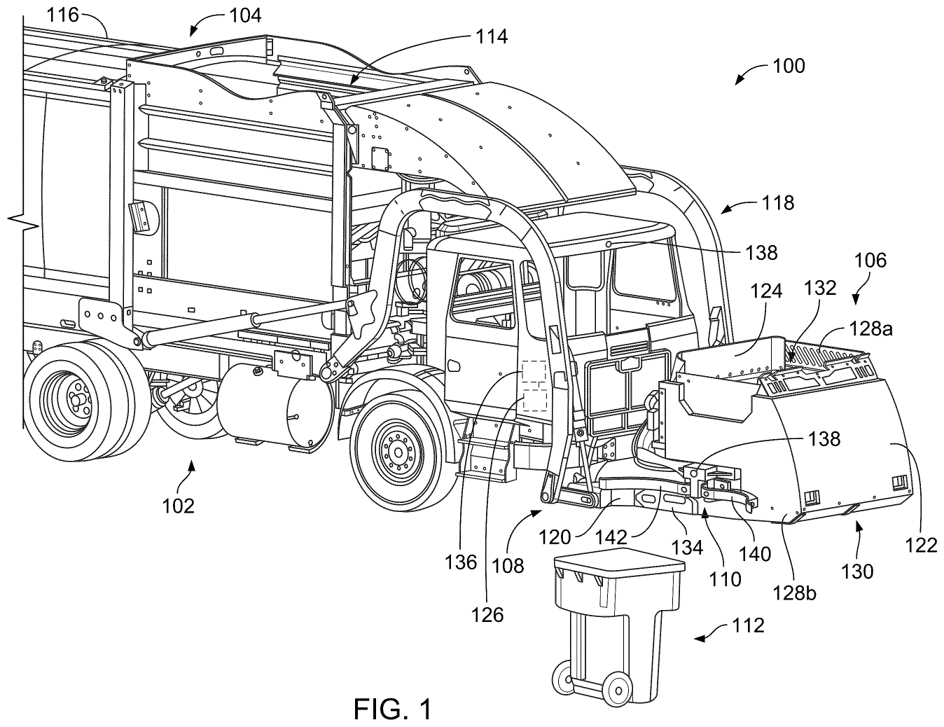

FIG. 1 depicts an example refuse collection vehicle 100. The refuse collection vehicle 100 operates to collect and transport refuse (e.g., garbage and/or recycling). The refuse collection vehicle 100 can also be described as a garbage collection vehicle, or garbage truck. The refuse collection vehicle 100 has a wheeled vehicle chassis 102, a refuse collecting body 104 supported by the wheeled vehicle chassis 102, an intermediate container 106, a front loading arm assembly 108, and a grabber arm assembly 110 for engaging, repositioning, and disengaging a customer refuse container 112 to deposit the refuse from the customer refuse container 112 into the intermediate container 106. The intermediate container 106 is positioned in front of the refuse collection vehicle 100 and is coupled to the front loading arm assembly 108. The intermediate container 106 receives refuse from the customer refuse container 112. The front loading arm assembly 108 repositions the intermediate container 106 to deposit the refuse into the refuse collecting body 104 to enable transporting the refuse to a collection site, compacting of the refuse, and/or other refuse handling activities.

The body components of the refuse collection vehicle 100 can include various components that are appropriate for the particular type of refuse collection vehicle 100. A front loading vehicle, such as the example shown in FIG. 1, may include body components involved in the operation of the vehicle 100, such as a pump, tailgate, packer, front loading arm assembly 108, and so forth. Alternatively, the vehicle may be a side-loading truck with an automated side loader (ASL), a rear loading truck, a roll off truck, or some other type of garbage collection vehicle. A side loader may include such components as an arm and/or grabbers, as well as other body components such as a pump, a tailgate, a packer, and so forth. A rear loading vehicle may include body components such as a pump, blade, tipper, and so forth. A roll off vehicle may include body components such as a pump, hoist, cable, and so forth. Body components may also include other types of components that operate to load garbage into a hopper 114 (or other storage area) of the refuse collecting body 104, compress and/or arrange the garbage in the vehicle, and/or expel the garbage from the vehicle.

The refuse collecting body 104 has a storage body 116, a track extending along a floor of the storage body 116, and a refuse packer (also referred to as a packer panel, an ejector, and an ejector panel, among other terms). The refuse packer slides along tracks within the storage body 116 between a forward (retracted) position, and a rearward (extended) position to compact the refuse and move the refuse out of the hopper 114 and into the storage body 116.

The front loading arm assembly 108 includes a lift arm assembly 118 and forks 120. The vehicle 100 may include other types of components that operate to bring garbage into a hopper 114 of the vehicle 100, compress and/or arrange the garbage in the vehicle 100, and/or expel the garbage from the vehicle 100.

Front end loading refuse collection vehicles (such as vehicle 100) are typically used for commercial refuse collection, where large bins of garbage or recyclables are engaged with the front forks of the vehicle and lifted overhead to be emptied into a hopper behind the cab of the vehicle. In order to service residential refuse containers (also referred to herein as residential bins), the intermediate container 106 can be coupled to the forks 120 and used to collect refuse from residential refuse containers. An example intermediate container 106 for collecting refuse is sold under the brand Curotto-Can®.

The intermediate container 106 for collecting refuse is coupled to the front loading arm assembly 108 of the vehicle 100. The intermediate container 106 has an overall box shape with a front wall 122, a rear wall 124, sidewalls 128a, 128b, a bottom 130 and an open top 132. Refuse can be loaded into the intermediate container 106 through the open top 132. The intermediate container 106 includes a pair of channels 134 extending along the sidewalls 128a, 128b that allow the forks 120 to pass through to enable the vehicle 100 to lift and transport the intermediate container 106. The intermediate container 106 can remain coupled to the front loading arm assembly 108 while the vehicle 100 is in motion.

The grabber arm assembly 110 is coupled to the vehicle 100 and is operable to engage, lift, and invert the customer refuse container 112 (e.g., a residential refuse bin) to empty the contents of the customer refuse container 112 into the intermediate container 106. The grabber arm assembly 110 can be extended, retracted, and moved to grab the customer refuse container 112 and empty the refuse container 112 into the intermediate container 106. The refuse is retained in the intermediate container 106 until it is dumped into the hopper 114 of the vehicle 100. Once the intermediate container 106 is sufficiently full, the lift arm assembly 118 of the vehicle 100 lifts the intermediate container 106 to dump its contents into the hopper 114 of the vehicle 100.

The vehicle 100 can include an onboard computing device 136 to manage, monitor, and/or operate various body components of the vehicle 100. The onboard computing device 136 can be connected to multiple sensors 138 in the vehicle. The onboard computing device 136 can transmit one or more signals over a network or wiring on the vehicle 100 when the onboard computing device 136 senses a state change from any of the sensors 138. The onboard computing device 136 can operate one or both of the grabber arm assemblies 110 to deposit the refuse from the customer refuse container 112 into the intermediate container 106, and operate the lift arm assembly 118 to deposit the contents of the intermediate container 106 into the hopper 114 based on an operator input or input from one or more of the sensors in the vehicle. For example, the sensor 138 can sense conditions of the grabber arm assembly 110, the intermediate container 106, and/or the customer refuse container 112. The sensor 138 of the grabber arm assembly control system can sense a configuration of the grabber arm assembly 110 and transmit a signal representing the configuration of the grabber arm assembly 110 to the controller 136. The configuration of the grabber arm assembly 110 can include one or more of the open or closed positions of the first grabber arm 140 and the second grabber arm 142, a movement and a direction of the movement of the first grabber arm 140 and the second grabber arm 142.

The onboard computing device 136 can include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The onboard computing device 136 can include a processor, a memory, a storage device, and an input/output device. Each of the components are interconnected using a system bus. The processor is capable of processing instructions for execution within the vehicle 100. The processor may be designed using any number of architectures. For example, the processor may be a Complex Instruction Set Computer (CISC) processor, a Reduced Instruction Set Computer (RISC) processor, or a Minimal Instruction Set Computer (MISC) processor.

The processor can be a single-threaded processor. In another implementation, the processor is a multi-threaded processor. The processor is capable of processing instructions stored in the memory or on the storage device to display graphical information for a user interface on the input/output device.

The memory stores information within the onboard computing device 136. In one implementation, the onboard computing device 136 is a computer-readable medium. In another implementation, the memory is a volatile memory unit. In yet another implementation, the memory is a non-volatile memory unit.

The storage device is capable of providing mass storage for the onboard computing device 136. In one implementation, the storage device is a computer-readable medium. In various different implementations, the storage device may be a floppy disk device, a hard disk device, an optical disk device, or a tape device.

The input/output device provides input/output operations onboard computing device 136. In one implementation, the input/output device includes a joystick. In other implementations, the input/output device includes a display unit for displaying graphical user interfaces. For example, in some implementations, the input/output device is a display device that includes one or more buttons and/or a touchscreen for receiving input from a user. In some implementations, the input/output device includes a keyboard and/or a pointing device. In some implementations, the input/output device is located within a cab of a refuse collection vehicle (e.g., within the vehicle 100). For example, the input/output device can be attached to, or incorporated within, a dashboard inside the cab of a refuse collection vehicle.

The vehicle 100 can include a display in the cab of the vehicle to display images and/or video received from one or more cameras positioned on the vehicle 100. For example, a display can be used to monitor image and/or video data of the grabber arm assembly 110 engaging and servicing the customer refuse container 112.

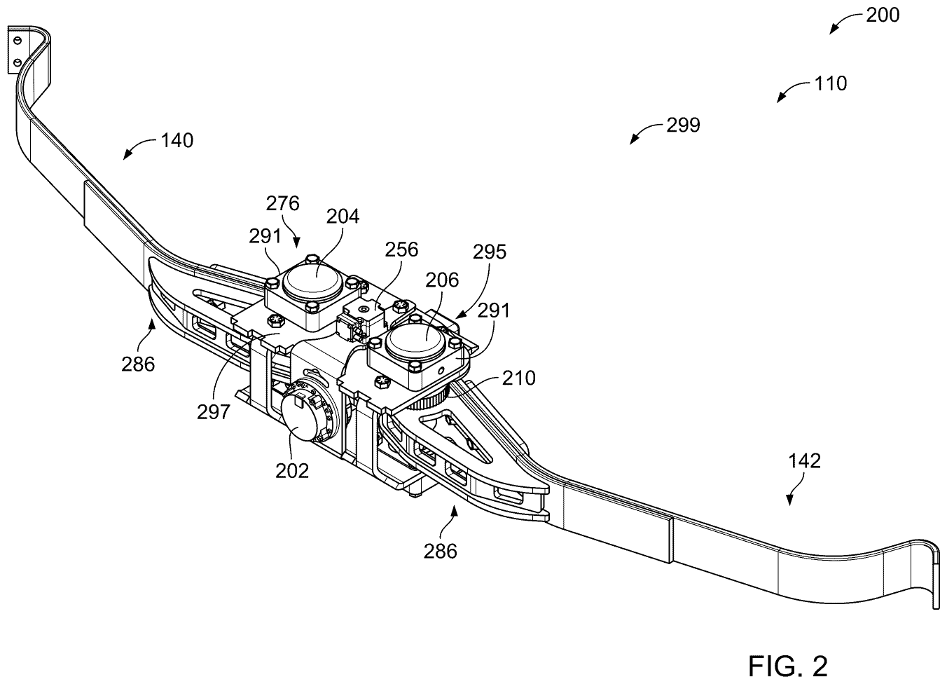

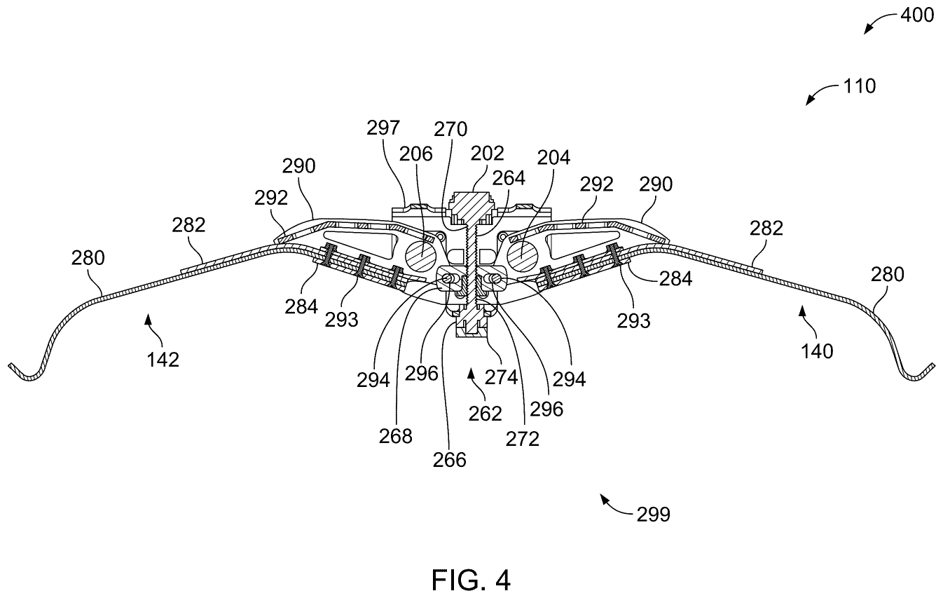

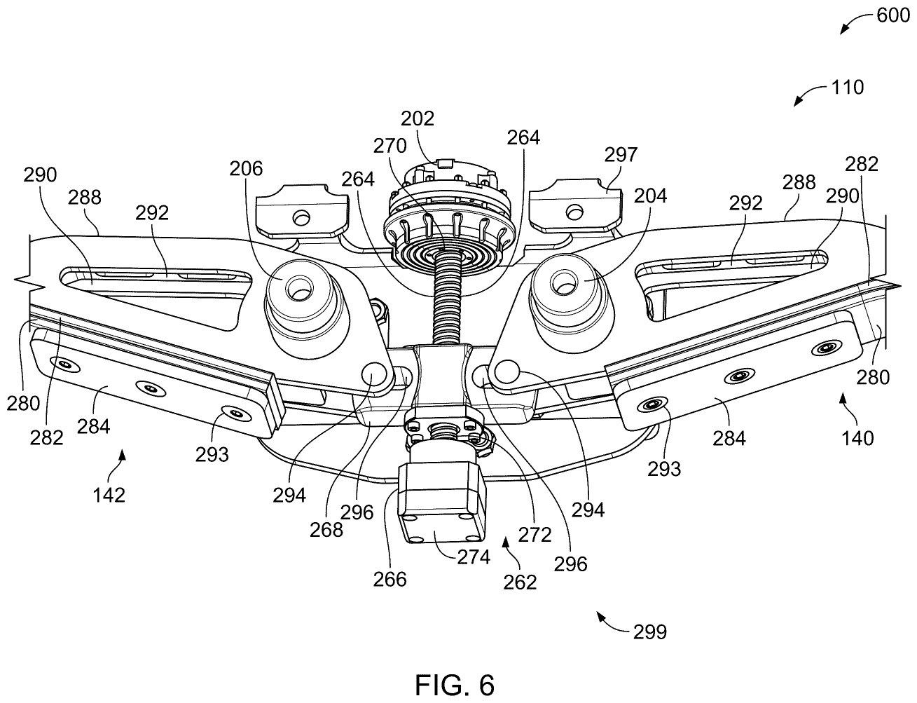

The vehicle 100 has an electrical power source 126 to generate, store, and/or supply electricity to one or more device, systems, or sub-systems of the vehicle 100. In this implementation, the electrical power source 126 is operatively controlled by the controller 136. The electrical power source 126 supplies electricity to the grabber arm assembly 110 to operate the grabber arm assembly 110 for engaging, repositioning, and disengaging the customer refuse container 112. For example, the grabber arm assembly 110 can include one or more electrically operated hydraulic control valves or motors which are described in reference to FIGS. 2-10. The electrical power source 126 can be one or more of a battery, a generator, or a solar panel.

Referring to FIGS. 2-10, the grabber arm assembly 110 has a first grabber arm 140 and a second grabber arm 142. The first grabber arm 140 and the second grabber arm 142 are operable to engage and disengage the customer refuse container 112.

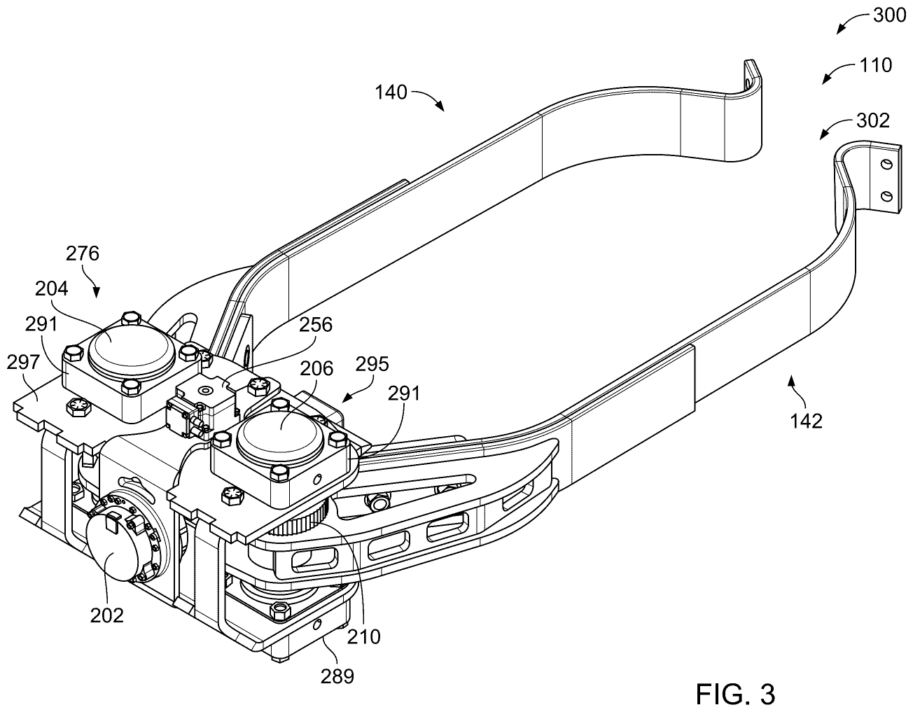

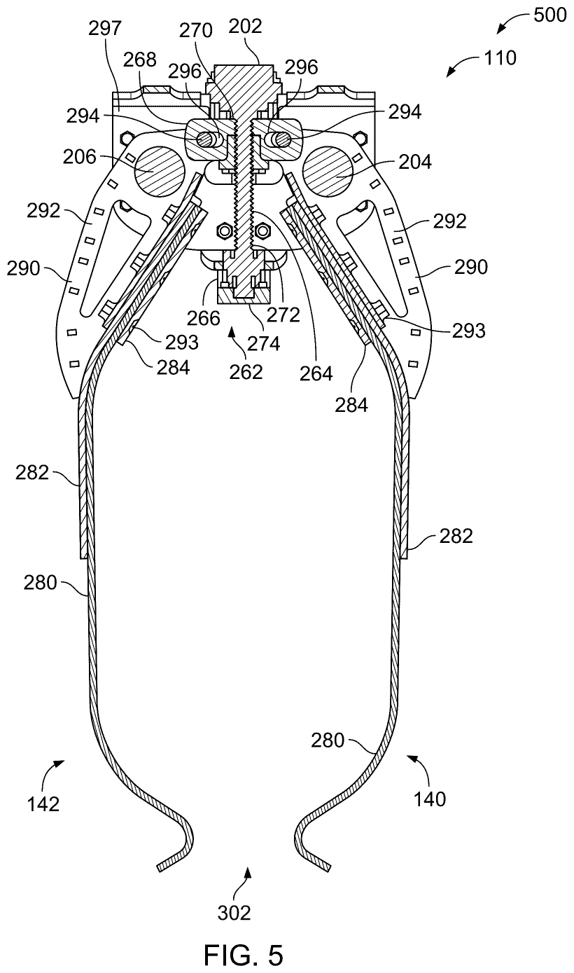

The first grabber arm 140 and the second grabber arm 142 are rotatable between an open position 299 (shown in FIGS. 1, 2, 4, and 6-10) and a closed position 302 (shown in FIGS. 3 and 5). When the first grabber arm 140 and the second grabber arm 142 are in the open position 299, they are arranged to accept the customer refuse container 112 as the grabber arm assembly 110 is moved into a position to engage the customer refuse container 112. The sensor 138 can sense conditions and the configuration of the grabber arm assembly 110, the intermediate container 106, and/or the customer refuse container 112. The sensor 138 can then transmit a signal representing the configuration and condition of the grabber arm assembly 110 and the customer refuse container 112 to the controller 136, such as the first grabber arm 140 and the second grabber arm 142 in either or between the open position 299 or closed position 302, movement and direction of the movement of the first grabber arm 140 and the second grabber arm 142, the presence of the customer refuse container 112, or the first grabber arm 140 and the second grabber arm 142 engaged to the customer refuse container 112. When the first grabber arm 140 and the second grabber arm 142 are moved to the closed position 302 and the customer refuse container 112 is in an acceptable position and range, the first grabber arm 140 and the second grabber arm 142 engage the customer refuse container 112. The sensor 138 can sense when the first grabber arm 140 and the second grabber arm 142 are engage the customer refuse container 112 and transmit a signal to the controller 136 when each of these conditions are met. The first grabber arm 140 and the second grabber arm 142 operating together in the closed position 302 engage the customer refuse container 112 with a force sufficient to maintain control of the customer refuse container 112 as the grabber arm assembly 110 lifts the customer refuse container 112 from the ground, moves the customer refuse container 112, tilts the customer refuse container 112 to deposit the refuse contained in the customer refuse container 112 into the intermediate container 106, returns the customer refuse container 112 to the ground, and releases the customer refuse container 112 back onto the ground as the first grabber arm 140 and the second grabber arm 142 move back to the open position 299. The sensor 138 can sense when the first grabber arm 140 and the second grabber arm 142 are engage the customer refuse container 112 and transmit a signal to the controller 136 when each of these actions are commenced and/or completed.

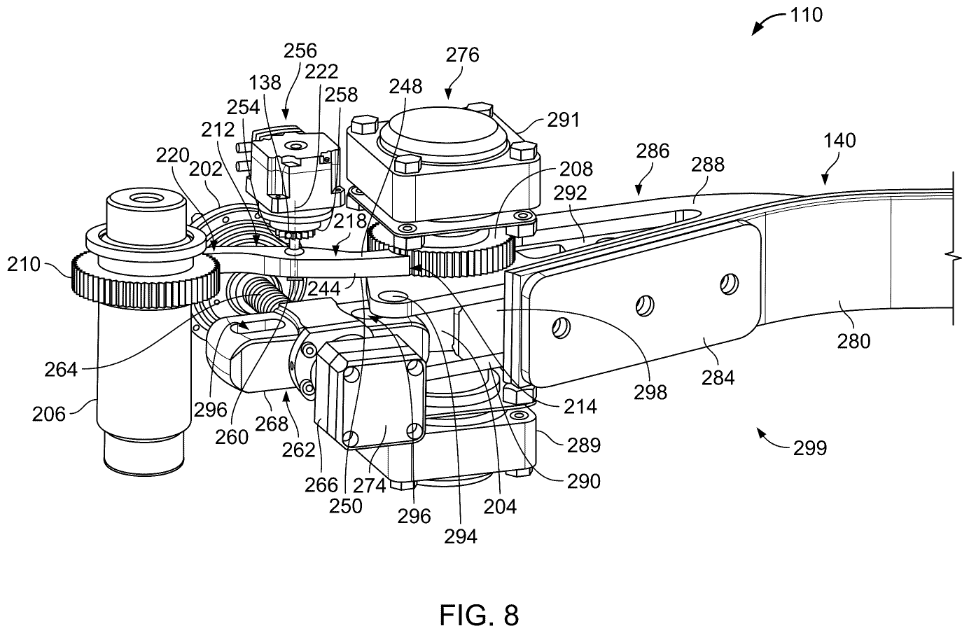

Referring to FIGS. 8-10, the grabber arm assembly 110 has a grabber motor 202 to move the first grabber arm 140 and the second grabber arm 142 between the open position 299 and the closed position 302 by rotating the first grabber arm 140 and the second grabber arm 142 around respective first and second pivot pins 204, 206 of the grabber arm assembly 110. In this implementation, the grabber motor 202 is a ball screw motor. Electricity is supplied from the electrical power source 126 to the grabber motor 202 to move the first grabber arm 140 and the second grabber arm 142 between the open position 299 and closed position 302.

The grabber arm assembly 110 has a ball screw assembly 262 coupled to the grabber motor 202 to actuate the first grabber arm 140 and the second grabber arm 142 between the open position 299 and closed position 302. The ball screw assembly 262 has a ball screw shaft 264, a ball screw bearing 266, and a housing 268. In example implementations, the ball screw shaft 264, the ball screw bearing 266, and the housing 268 form a screw jack that operates to move the first grabber arm 140 and the second grabber arm 142. The ball screw assembly 262 is a linear actuator mechanism.

The ball screw shaft 264 has a first end 270 and a second end 272. The first end 270 of the ball screw shaft 264 is rotatably coupled to the grabber motor 202. The second end 272 of the ball screw shaft 264 is coupled to the ball screw bearing 266. The second end 272 of the ball screw shaft 264 is supported by the ball screw bearing 266 and free to rotate in the clockwise or counterclockwise direction responsive to the grabber motor 202 imparting a clockwise or counterclockwise force to the ball screw shaft 264. The ball screw shaft 264 is threaded. The ball screw shaft 264 extends through the housing 268 and is coupled to the housing 268 by the threads.

The housing 268 is coupled to the ball screw shaft 264 and slides along the ball screw shaft 264 along a longitudinal axis of the ball screw shaft 264 between the first end 270 and the second end 272. The housing 268 is coupled to the first grabber arm 140 and the second grabber arm 142 and translates the rotational motion of the ball screw shaft 264 into linear motion by rotating the first grabber arm 140 and the second grabber arm 142 around the pivot pins 204, 206. The housing 268 moves along the ball screw shaft 264 responsive to rotation of the ball screw shaft 264 by the grabber motor 202. Responsive to the housing 268 moving along the ball screw shaft 264, the first grabber arm 140 and the second grabber arm 142 move between the open position 299 and closed position 302.

The housing 268 has voids 296 to through which pins 294 attach the first grabber arm 140 and the second grabber arm 142 to the ball screw assembly 262. The voids 296 are sized to allow the pins 294 limited movement. The voids 296 act to inhibit movement at the limits of travel, thus restricting inward and outward movement and motion of the first grabber arm 140 and the second grabber arm 142.

The grabber arm assembly 110 has a pad 274 coupled to the ball screw bearing 266. The pad 274 is rubber and protects the ball screw bearing 266 from impact with the customer refuse container 112.

The grabber arm assembly 110 has a first bearing assembly 276 coupled to a frame 297 of the grabber arm assembly 110 supporting and containing both ends of the pivot pin 204. The grabber arm assembly 110 has a second bearing assembly 295 coupled to the frame 297 of the grabber arm assembly 110 supporting and containing both ends of the pivot pin 206. The first bearing assembly 276 and the second bearing assembly 295 each have upper bearings 291 and lower bearings 289 engaged to the pivot pins 204, 206 to allow rotation within the respective bearing assemblies 276. The pivot pins 204, 206 are only constrained between the respective upper bearing 291 and lower bearings 289 and are free to move rotationally, and are therefore only permitted one degree of freedom, allowing the first grabber arm 140 and the second grabber arm 142 to move when driven by the grabber motor 202. In this implementation, the upper bearing 291 and lower bearing 289 are thrust bearings, however, any suitable bearing type may be used.

The first grabber arm 140 is coupled to the pivot pin 204 of the first bearing assembly 276 and the second grabber arm 142 is rotatably coupled to the pivot pin 206 of the second bearing assembly 295. The first grabber arm 140 and the second grabber arm 142 each include a gripper 280, a gripper support plate 282, a front retaining plate 284, a back retaining plate 298 and a gripper support structure 286. The gripper 280 contacts and engages the customer refuse container 112 when the grabber arm assembly 110 is engaging the refuse container 112. The gripper support plate 282 and the front retaining plate 284 sandwich the gripper 280. Fasteners 293 extend through the front retaining plate 284, the gripper 280, the gripper support plate 282, and into the back retaining plate 298 to couple the gripper 280 to the gripper support structure 286 and hold the gripper 280, the gripper support plate 282, the front retaining plate 284, and the back retaining plate 298 together and couple the gripper 280 to the gripper support structure 286. In this implementation, the fasteners 293 are bolts and nuts, however, any suitable fastener may be used.

The gripper support structure 286 has a top plate 288, a bottom plate 290 opposite the top plate 288, and a support plate 292 extending between the top plate 288 and the bottom plate 290.

The gripper support structure 286 forms a rigid hollow frame with apertured outer walls. This design provides sufficient support for the gripper 280, the gripper support plate 282, the front retaining plate 284, the back retaining plate 298 and is particularly light weight.

The pivot pin 204 extends through the top plate 288 and the bottom plate 290. The top plate 288 and the bottom plate 290 are fixed to the pivot pin 204.

The top plate 288 and the bottom plate 290 are coupled to the housing 268 by a pin 294. Pin 294 is slideable within a void 296 of the housing 268 as the housing 268 moves along the ball screw shaft 264.

In conventional grabber arm assemblies, when a refuse collection vehicle is operating, either stationary or while moving to another customer refuse container or to the dump, the position of each of the grabber arms is maintained by a continuous supply of electricity to a grabber motor coupled to the grabber arms, which can waste the limited electrical power of the vehicle. This source of waste can be reduced or even eliminated by using the grabber arm assembly 110.

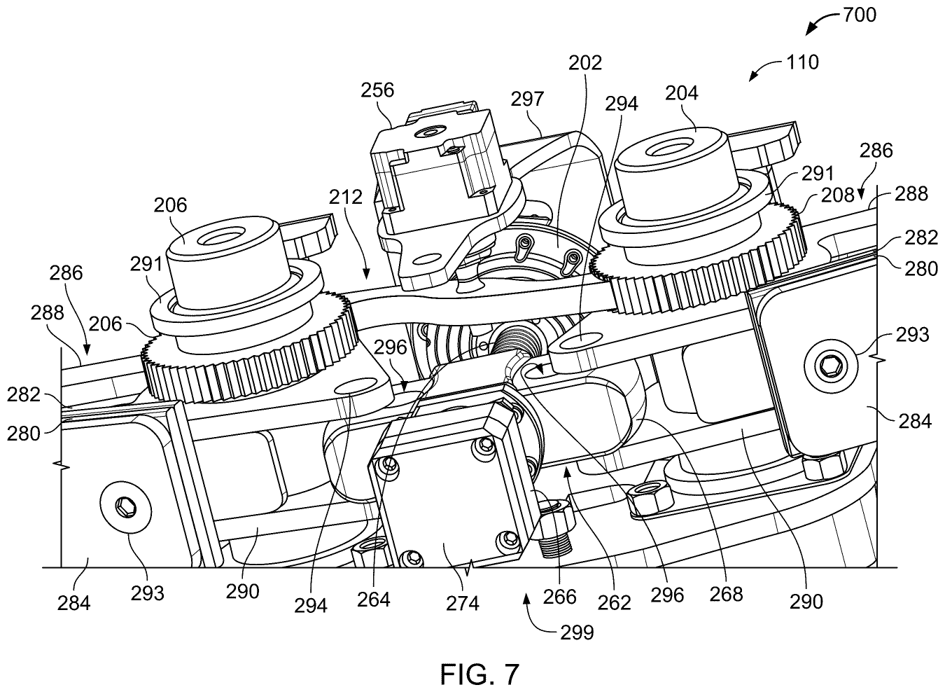

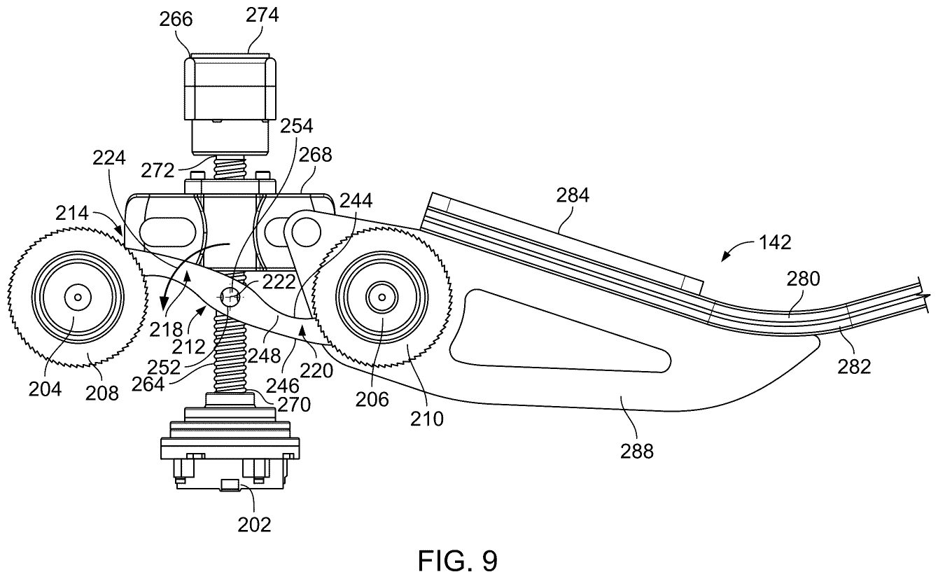

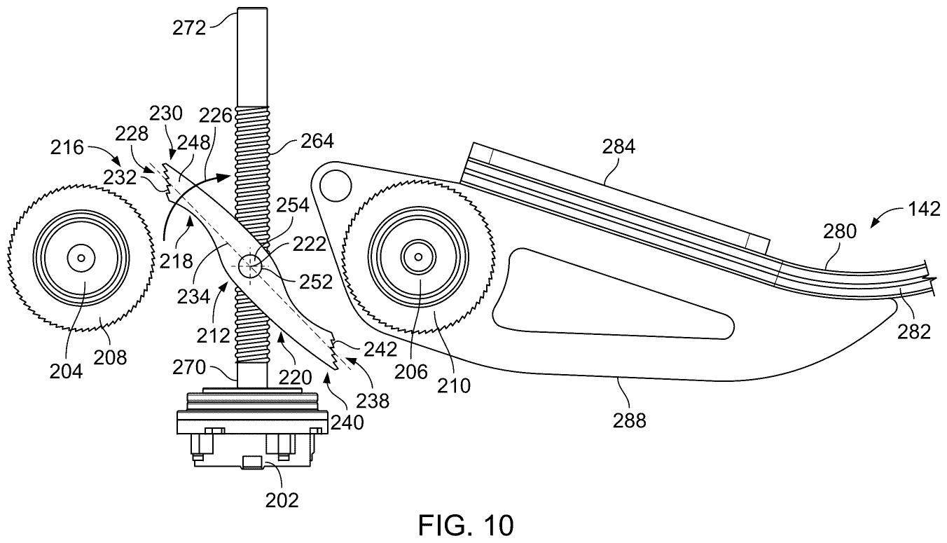

Referring to FIGS. 7-10, the grabber arm assembly 110 includes features to reduce consumption of electrical power. In FIG. 8, only the first grabber arm 140 is shown for clarity. In FIGS. 9-10, only the second grabber arm 142 is shown for clarity.

In this implementation, the grabber arm assembly 110 has a first ratchet gear 208 coupled to the first pivot pin 204, a second ratchet gear 210 coupled to the second pivot pin 206, and a ratcheting pawl 212 which is rotatable to engage and disengage the first ratchet gear 208 and the second ratchet gear 210. The ratcheting pawl 212 is operable between an engaged position 214, as shown in FIGS. 8 and 9, and a disengaged position 216, as shown in FIG. 10. Referring to FIGS. 8 and 9, when the ratcheting pawl 212 is in the engaged position 214, the ratcheting pawl 212 is in physical contact with the first ratchet gear 208 and the second ratchet gear 210, and rotation of the first grabber arm 140 and the second grabber arm 142 is prevented by the contact between the ratcheting pawl 212 and the rachet gears 208, 210. For example, when the vehicle 100 is in transition between locations to collect refuse from different customer refuse containers 112, the ratcheting pawl 212 is rotated into the engaged position 214 to engage the first ratchet gear 208 and the second ratchet gear 210 in order to maintain the first grabber arm 140 and the second grabber arm 142 in the open position 299. By using the ratcheting pawl 212 to maintain the position of the grabber arms 140, 142, the grabber motor 202 does not need to be operated to maintain the grabber arm position and the flow of electricity to the grabber motor 202 can be stopped, eliminating this source of waste of the limited electrical power of the vehicle 100.

When the ratcheting pawl 212 is in the disengaged position 216, the ratcheting pawl 212 is spaced apart from and is not in physical contact with the first ratchet gear 208 and the second ratchet gear 210, and therefore does not prevent rotation of the first grabber arm 140 and the second grabber arm 142. For example, when the operator is actuating the first grabber arm 140 and the second grabber arm 142 to engage or disengage the customer refuse container 112, the ratcheting pawl 212 is in the disengaged position 216 so that the first grabber arm 140 and the second grabber arm 142 are free to rotate about the pivot pins 204, 206 when moved by the grabber motor 202.

The ratcheting pawl 212 has two arms, a first arm 218 and a second arm 220, both extending from a center axis 222. The two arms 218 and 220 extend co-linearly in opposite directions from the center axis 222. The ratcheting pawl 212 rotates about the center axis between the disengaged position 216 and the engaged position 214. Specifically, referring to FIG. 9, the ratcheting pawl 212 rotates in a counterclockwise direction 224 to move from the disengaged position 216 to the engaged position 214 and, referring to FIG. 10, the ratcheting pawl 212 rotates in a clockwise direction 226 to move from the engaged position 214 to the disengaged position 216.

The ratcheting pawl 212 has a first surface 228 on a first end 230 (i.e., the terminating end of the first arm 218 away from the center axis 222). The first surface 228 is curved to match the profile of the first ratchet gear 208. The first surface 228 has multiple teeth 232 to engage the first ratchet gear 208. The teeth 232 are angled offset from perpendicular to the first surface 228 to engage the first ratchet gear 208. The first surface 228 is angled relative to a longitudinal axis 234 of the ratcheting pawl 212 such that, as the ratcheting pawl 212 rotates about the center axis 222, the teeth 232 can engage and disengage the first ratchet gear 208.

The ratcheting pawl 212 also has a second surface 238 on a second end 240 (i.e., the terminating end of the second arm 220 away from the center axis 222). The second surface 238 is curved to match the profile of the second ratchet gear 210. The second surface 238 has multiple teeth 242 to engage the second ratchet gear 210. The teeth 242 are angled offset from perpendicular to the second surface 238 to engage the second ratchet gear 210. The teeth 242 on the second end 240 are oriented opposite the teeth 232 of the first end 230. The second surface 238 is angled relative to a longitudinal axis 234 of the ratcheting pawl 212 at an angle other than perpendicular, and parallel to the first surface 228 so that, as the ratcheting pawl 212 rotates about the center axis 222, the teeth 242 can engage and disengage the second ratchet gear 210.

The ratcheting pawl 212 has side surfaces 244, 246 extending between the first surface 228 and the second surface 238. The side surfaces 244, 246 are curved.

The ratcheting pawl 212 has a top surface 248 and a bottom surface 250 opposite the top surface 248. The top surface 248 and the bottom surface 250 extend between the first surface 228 and the second surface 238. The top surface 248 and the bottom surface 250 are perpendicular to the side surfaces 244, 246.

The ratcheting pawl 212 defines a void 252 extending from the top surface 248 to the bottom surface 250 of the ratcheting pawl 212. The void 252 is generally cylindrically shaped and has locking surfaces shaped to receive locking surfaces of an axle 254.

The grabber arm assembly 110 has a ratcheting pawl motor 256 which is operatively coupled to the ratcheting pawl 212 by the axle 254. The ratcheting pawl motor 256 rotates the ratcheting pawl 212 between the disengaged position 216 and the engaged position 214. The ratcheting pawl motor 256 is a bi-directional motor capable of rotating the ratcheting pawl 212 in the clockwise direction 226 and the counterclockwise direction 224 by rotating the axle 254.

The grabber arm assembly 110 has a ratcheting pawl motor plate 258. The ratcheting pawl motor plate 258 couples the axle 254 to the ratcheting pawl motor 256. The ratcheting pawl motor plate 258 is coupled to a bottom surface of the ratcheting pawl motor 256 with multiple bolts and washers. The bolts extend through the ratcheting pawl motor plate 258 to couple the ratcheting pawl motor plate 258 to the ratcheting pawl motor 256.

The axle 254 extends into the void 252 defined in the ratcheting pawl 212. The axle 254 is further coupled to the ratcheting pawl 212 by a bolt and washer 260.

The grabber arm assembly 110 can include a control system to operate the grabber motor 202 and the ratcheting pawl motor 256. In some implementations, the grabber arm assembly control system is a part of the controller 136. In some implementations, the grabber arm assembly control system includes sensors. For example, the sensor 138 can senses conditions of the grabber arm assembly 110, the intermediate container 106, and/or the customer refuse container 112. The sensor 138 can sense a configuration of the grabber arm assembly 110 and transmit a signal representing the configuration of the grabber arm assembly 110 to the controller 136. The configuration of the grabber arm assembly 110 can include one or more of the open position 299 or closed position 302 of the first grabber arm 140 and the second grabber arm 142, a movement and a direction of the movement of the first grabber arm 140 and the second grabber arm 142, the engaged position 214 or disengaged position 216 of the ratcheting pawl 212, the presence or lack of presence of electrical power being supplied to the ratcheting pawl motor 212, a rotational angle of the axle 254, the presence or lack of presence of electrical power being supplied to grabber motor 202, a rotation, a direction of the rotation, and/or a speed of rotation of the ball screw shaft 264, a movement of housing 268, a presence of the housing 268 at a travel limit along the ball screw shaft 264, a presence of the customer refuse container 112, or the first grabber arm 140 and the second grabber arm 142 engaged to the customer refuse container 112.

The controller 136 is operatively coupled to the grabber arm assembly 110. The controller 136 can perform operations including receiving the signal representing the configuration of the grabber arm assembly 110, receiving an input command, and based on the input command and configuration of the grabber arm assembly 110, operating the grabber arm assembly 110. The input command can be an automated command based on vehicle 100 conditions, customer refuse container 112 conditions (i.e., empty, partially full, full, or a presence of a contaminant in the customer refuse), or a quantity of the refuse in the intermediate container 106. The input command can be a manual command from a local or remote operator.

Operating the grabber arm assembly 110 can include the controller 136 generating a command signal to the grabber arm assembly 110 to begin or stop operating. For example, the command signal can be a clockwise command signal or a counterclockwise command signal transmitted from the controller 136 to the ratcheting pawl motor 256. Operating the grabber arm assembly 110 can include, responsive to receiving the clockwise command signal or the counterclockwise command signal from the controller 136 at the ratcheting pawl motor 256, the ratcheting pawl motor 256 rotating the ratcheting pawl 212 between the engaged position 214 and the disengaged position 216.

Operating the grabber arm assembly 110 can include rotating the ratcheting pawl 212 from the disengaged position 216 to the engaged position 214 responsive to receiving the counterclockwise command signal from the controller 136 at the ratcheting pawl motor 256. The sensor 138 can then detect the position of the ratcheting pawl 212 in the engaged position 214 and send a signal to the controller 136 indicating the ratcheting pawl 212 is in the engaged position 214. With the ratcheting pawl 212 in the engaged position 214, rotation of the first grabber arm 140 and the second grabber arm 142 is prevented. Based on receiving the signal that the ratcheting pawl 212 is in the engaged position 214 at the controller 136, the controller 136 can stop a flow of electrical power to the grabber motor 202.

Operating the grabber arm assembly 110 can include, responsive to receiving the clockwise command signal from the controller 136 at the ratcheting pawl motor 256, the ratcheting pawl motor 256 can rotate from the engaged position 214 to the disengaged position 216. With the ratcheting pawl 212 in the disengaged position 216, rotation of the first grabber arm 140 and the second grabber arm 142 is not prevented. Based on receiving the signal that the ratcheting pawl 212 is in the disengaged position 216 at the controller 136, the controller 136 can stop a flow of electrical power to the grabber motor 202.

Operating the grabber arm assembly 110 can include the controller 136 generating a command signal to the grabber motor 202 to operate. For example, the command signal can be a clockwise command signal or a counterclockwise command signal transmitted from the controller 136 to the grabber motor 202.

Referring to FIGS. 8-10, a method of controlling a position of the first grabber arm 140 and second grabber arm 142 of the refuse collection vehicle 100 is described. At 502, the ratcheting pawl 212 of the grabber arm assembly 110 of the refuse collection vehicle 100 is rotated from a disengaged position 216 to an engaged position 214. Rotation of the ratcheting pawl 212 can be manually controlled by the operator of the refuse collection vehicle 100. Rotation of the ratcheting pawl 212 can be partially controlled by the operator or automatically controlled by the onboard controller 136. For example, the controller 136 can receive a signal indicating that the first grabber arm 140 and second grabber arm 142 are being moved from the closed position 302 to the open position 299. For example, after releasing the customer refuse container 112, the first grabber arm 140 and second grabber arm 142 can be rotated from the closed position 302 to the open position 299. Once in the first grabber arm 140 and second grabber arm 142 are in the open position 299, as detected by the sensor 138, the onboard controller 136 transmits a signal to the ratcheting pawl motor 256 to cause the ratcheting pawl motor 256 to rotate the ratcheting pawl 212 in the counterclockwise direction 224. The ratcheting pawl motor 256 continues to operate to move the ratcheting pawl 212 in a counterclockwise direction 224 until the sensor 138 monitoring the position of the ratcheting pawl 212 indicates that the ratcheting pawl 212 is in the engaged position 214. For example, referring to FIG. 9, the ratcheting pawl motor 256 rotates the axle 254 in the counterclockwise direction 224, engaging the teeth 232, 242 to the first ratchet gear 208 and the second ratchet gear 210, respectively.

At 504, responsive to rotating the ratcheting pawl from the disengaged position to the engaged position, rotation of the first grabber arm and a second grabber arm is prevented. For example, referring to FIG. 9, when the first and second arms 218, 220 of the ratcheting pawl 212 are in contact with the first ratchet gear 208 and the second ratchet gear 210, rotation of the first and second pivot pins 204, 206 is prevented, and thus, the first grabber arm 140 and a second grabber arm 142 are unable to rotate.

At 506, the ratcheting pawl is rotated the from the engaged position to the disengaged position. For example, the controller 136 can receive a signal from the sensor 138 indicating the presence of the customer refuse container 112 requiring emptying and in a position for pickup that is able to be engaged by the first grabber arm 140 and the second grabber arm 142. The controller 136 can generate a command signal to the ratcheting pawl motor 256 to rotate the ratcheting pawl 212 in the clockwise direction to the disengaged position 216. The ratcheting pawl 212 is then rotated to the disengaged position. The controller 136 generates a command signal to the grabber motor 202, and the grabber motor 202 moves the first grabber arm 140 and second grabber arm 142 are being moved from the open position 299 to the closed position 302 to engage the customer refuse container 112. Once the first grabber arm 140 and the second grabber arm 142 are engaged to the customer refuse container 112, the grabber arm assembly 110 repositions the customer refuse container 112 to deposit the refuse from the customer refuse container 112 into the intermediate container 106, repositions the customer refuse container 112 to the ground, and disengages the a customer refuse container 112 by rotating the first grabber arm 140 and the second grabber arm 142 from the closed position 302 to the open position 299. For example, referring to FIG. 10, the ratcheting pawl motor 256 rotates the axle 254 in the clockwise direction 226, disengaging the teeth 232, 242 from the first ratchet gear 208 and the second ratchet gear 210, respectively.

At 508, responsive to rotating the ratcheting pawl from the engaged position to the disengaged position, rotation of the first grabber arm and the second grabber arm is not prevented. For example, referring to FIG. 10, when the first and second arms 218, 220 of the ratcheting pawl 212 are disengaged to the first ratchet gear 208 and the second ratchet gear 210, rotation of the first and second pivot pins 204, 206 is allowed, and thus, the first grabber arm 140 and a second grabber arm 142 are free to rotate responsive to operation of the grabber motor 202.

For example, the method of controlling the position of the first and second grabber arms of the refuse collection vehicle can include additional steps. For example, the method can include sensing a configuration of the grabber arm assembly and transmitting a signal representing the configuration of the grabber arm assembly.

The method can include receiving the signal representing the configuration of the grabber assembly; receiving an input command; and based on the input command and configuration of the grabber assembly, operating the grabber arm assembly. Sensing the configuration of the grabber assembly can include sensing a condition of the ratcheting pawl. The condition of the ratcheting pawl can include an indication of when the ratcheting pawl positioned in the disengaged position or the engaged position. The condition of the ratcheting pawl can include a rotational angle of an axle coupling the ratcheting pawl to a ratcheting pawl motor operatively coupled to the ratcheting pawl. The condition of the ratcheting pawl can be an energized state or a deenergized state of a ratcheting pawl motor operatively coupled to the ratcheting pawl. Where the ratcheting pawl motor operatively coupled to the ratcheting pawl is a bi-directional motor, the method can further include generating a clockwise command signal to rotate the ratcheting pawl motor in a clockwise direction and generating a counterclockwise command to rotate the ratcheting pawl motor in a counterclockwise direction.

Sensing the configuration of the grabber assembly can include sensing a condition of a grabber motor operatively coupled to the first grabber arm and the second grabber arm. Sensing the condition of the grabber motor can include an energized state or a deenergized state of the grabber motor.

Sensing the configuration of the grabber assembly can include sensing a position of the first grabber arm and the second grabber arm. The position of the first grabber arm and the second grabber arm can include an open position and a closed position.

The method of controlling the position of the first and second grabber arms of the refuse collection vehicle can include operating the grabber assembly by positioning the first grabber arm and the second grabber arm between the open position and the closed position. Operating the grabber arm assembly can include positioning the ratcheting pawl between the engaged position and the disengaged position.

Operating the grabber arm assembly can include rotating the ratcheting pawl from the disengaged position to the engaged position; responsive to rotating the ratcheting pawl from the disengaged position to the engaged position, preventing rotation of the first grabber arm and the second grabber arm; and stopping a flow of power to a grabber motor operatively coupled to the first grabber arm and the second grabber arm. Operating the grabber arm assembly can include rotating the ratcheting pawl from the engaged position to the disengaged position; responsive to rotating the ratcheting pawl from the engaged position to the disengaged position, not preventing rotation of the first grabber arm and the second grabber arm; and flowing power to the grabber motor.

A number of embodiments have been described. Nevertheless, it will be understood that various modifications may be made without departing from the spirit and scope of the disclosure.

For example, while the first surface 228 and the second surface 238 have been described as being curved, in some implementations, the first surface 228 and the second surface 238 can be flat surfaces.

In this embodiment, a ball screw assembly 262 is used to actuate the grabber arms 140, 142. In other cases, any suitable mechanical linkage and mechanical actuators may be used to open and close the grabber arms 140, 142. For example, one or two pistons or electric linear actuators, synchronized motors for each grabber arm 140, 142, or a single ratchet gear and motor may be used to actuate the grabber arms 140, 142.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claim(s).

What is claimed is:

1. A refuse collection vehicle comprising:
a wheeled vehicle chassis; and
a refuse collection body coupled to the wheeled vehicle chassis, the refuse collection body comprising a grabber assembly configured to engage a refuse container and position the refuse container relative to the refuse collection body, the grabber assembly comprising:
a first grabber arm and a second grabber arm, the first grabber arm and the second grabber arm configured to move between an open position and a closed position; and
a ratcheting pawl operable between an engaged position and a disengaged position, the ratcheting pawl configured to prevent rotation of the first grabber arm and the second grabber arm when the ratcheting pawl is in the engaged position.

2. The refuse collection vehicle of claim 1, wherein the ratcheting pawl, when in the disengaged position, does not prevent rotation of the first grabber arm and the second grabber arm.

3. The refuse collection vehicle of claim 1, wherein the ratcheting pawl rotates counterclockwise to move from the disengaged position to the engaged position and clockwise to move from the engaged position to the disengaged position.

4. The refuse collection vehicle of claim 1, wherein the grabber assembly further comprises a ratcheting pawl motor operatively coupled to the ratcheting pawl, the ratcheting pawl motor configured to rotate the ratcheting pawl between the disengaged position and the engaged position.

5. The refuse collection vehicle of claim 4, further comprising an axle coupling the ratcheting pawl to the ratcheting pawl motor, the ratcheting pawl rotatable about a center axis of the axle between the disengaged position and the engaged position.

6. The refuse collection vehicle of claim 1, wherein the grabber assembly further comprises:
a first bearing assembly coupled to the first grabber arm;
a second bearing assembly coupled to the second grabber arm;
a first ratchet gear coupled to a first pivot pin of the first bearing assembly; and
a second ratchet gear coupled to a second pivot pin of the second bearing assembly,
wherein the ratcheting pawl comprises:
a first surface configured to engage the first ratchet gear; and
a second surface configured to engage the second ratchet gear.

7. The refuse collection vehicle of claim 6, wherein the first surface and the second surface are curved or parallel flat surfaces.

8. The refuse collection vehicle of claim 6, wherein the first surface and the second surface are parallel flat surfaces.

9. The refuse collection vehicle of claim 6, wherein the first surface and the second surface are angled relative to a longitudinal axis of the ratcheting pawl.

10. The refuse collection vehicle of claim 6, wherein:
the first surface comprises a first plurality of teeth shaped to engage the first ratchet gear; and
the second surface comprises a second plurality of teeth shaped to engage the second ratchet gear.

11. The refuse collection vehicle of claim 10, wherein:
the first plurality of teeth is angled relative to the first surface; and
the second plurality of teeth is angled relative to the second surface.

12. The refuse collection vehicle of claim 10, wherein the first plurality of teeth is oriented in an opposite direction from the second plurality of teeth.

13. The refuse collection vehicle of claim 6, wherein the ratcheting pawl comprises:
a first arm configured to engage and disengage the first ratchet gear; and
a second arm configured to engage and disengage the second ratchet gear.

14. The refuse collection vehicle of claim 13, wherein side surfaces of the first arm and the second arm are curved.

15. The refuse collection vehicle of claim 1, wherein the grabber assembly further comprises a control system, the control system comprising:
a sensor configured to perform operations comprising:
sensing a configuration of the grabber assembly; and
transmitting a signal representing the configuration of the grabber assembly; and
a controller configured to perform operations comprising:
receiving the signal representing the configuration of the grabber assembly; and
based on the signal, controlling movement of the grabber assembly.

16. The refuse collection vehicle of claim 15, wherein sensing the configuration of the grabber assembly comprises:
sensing that the ratcheting pawl is positioned in the disengaged position or the engaged position; or
detecting a rotational angle of an axle coupling the ratcheting pawl to a ratcheting pawl motor operatively coupled to the ratcheting pawl.

17. The refuse collection vehicle of claim 15, wherein controlling movement of the grabber assembly comprises at least one of:
positioning the first grabber arm and the second grabber arm in the open position or the closed position;
positioning the ratcheting pawl in the engaged position or the disengaged position;
causing the ratcheting pawl to rotate from the disengaged position to the engaged position and stopping a flow of power to a grabber motor operatively coupled to the first grabber arm and the second grabber arm;
causing the ratcheting pawl to rotate from the engaged position to the disengaged position; or
causing power to be provided to the grabber motor.

18. A method comprising:
rotating a ratcheting pawl of a grabber assembly of a refuse collection vehicle from a disengaged position to an engaged position, wherein rotation of a first grabber arm and a second grabber arm is prevented when the ratcheting pawl is in the engaged position; and
rotating the ratcheting pawl from the engaged position to the disengaged position, wherein rotation of the first grabber arm and the second grabber arm is not prevented when the ratcheting pawl is in the engaged position.

19. The method of claim 18, further comprising:
sensing whether the ratcheting pawl positioned in the disengaged position or the engaged position,
wherein rotating the ratcheting pawl from the engaged position to the disengaged position comprises:
generating a clockwise command signal to rotate a ratcheting pawl motor coupled to the ratcheting pawl in a clockwise direction; based on receiving the clockwise command signal at the ratcheting pawl motor, rotating the ratcheting pawl from the engaged position to the disengaged position,
causing the ratcheting pawl to rotate from the engaged position to the disengaged position; and
causing power to be provided to a grabber motor operatively coupled to the first grabber arm and the second grabber arm, and
wherein rotating the ratcheting pawl from the disengaged position to the engaged position comprises:
generating a counterclockwise command signal to rotate the ratcheting pawl motor in a counterclockwise direction;
based on receiving the counterclockwise command signal at the ratcheting pawl motor, rotating the ratcheting pawl from the disengaged position to the engaged position;
causing the ratcheting pawl to rotate from the disengaged position to the engaged position; and
stopping a flow of power to the grabber motor.

20. A grabber system for loading refuse, comprising:
a frame;
a first arm assembly pivotally coupled to the frame;
a second arm assembly pivotally coupled to the frame; and
a linear drive mechanism coupled to the frame and operable to move the first arm assembly and the second arm assembly between an open position and a closed position to grab a refuse container.
